(19) United States
(12) Patent Application Publication
(10) Pub. No.: US 2004/0001932 A1
(43) Pub. Date: Jan. 1, 2004

(54) Device for protecting a surface from paint spray

(76) Inventors: Robert D. Krause, Granbury, TX (US); Terry Zangkas, Rochester Hills, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/462,551

(22) Filed: Jun. 16, 2003

Related U.S. Application Data
(60) Provisional application No. 60/388,785, filed on Jun. 14, 2002.

(51) Int. Cl. B32B 33/00

(52) U.S. Cl. 428/41.7; 118/504; 118/505

(57) ABSTRACT

A device for protecting a surface from paint spray in a paint spray booth having a plurality of flexible sheets. An adhesive is applied to at least a portion of one side of each sheet for both detachably securing the sheets together in a stack and also for detachably securing an end sheet in the stack to the surface to be protected. A tab is secured to each sheet which enables the removal of the sheet associated with the tab from the stack by peeling the sheet away using the tab. The sheets are preferably made of a transparent material.

### RELATED APPLICATION

This application claims priority of U.S. Provisional Patent Application Serial No. 60/388,785 filed Jun. 14, 2002, which is incorporated herein by reference.

### BACKGROUND OF THE INVENTION

I. Field of the Invention

The present invention relates to a device for protecting a surface from a paint spray.

II. Description of the Prior Art

In paint spray booths of the type used in the automotive industry, paint is typically applied to the vehicle by robotically controlled spray guns. The paint spray booth also typically includes a number of windows so that an operator positioned outside the paint spray booth is able to view the operation of the paint spray booth.

Not all of the paint sprayed by the paint spray gun adheres to the vehicle. Rather, both over spray as well as paint spray resulting from bounce back causes the paint from the paint spray guns to cover many of the surfaces within the paint spray booth. Indeed, after prolonged operation of the paint spray booth, the windows providing visibility to the interior of the booth become so obscured by the accumulated paint spray on the windows that it is necessary to shut down the paint spray booth and manually scrub the windows and other surfaces within the paint spray booth free of paint. This disadvantageously results in down time for the paint spray booth.

Additionally, the over spray as well as the bounce back spray covers other equipment within the paint spray booth. Such over spray or bounce back paint covers such equipment or other surfaces and also requires periodic cleaning.

### SUMMARY OF THE PRESENT INVENTION

The present invention provides a device which overcomes all of the above-mentioned disadvantages of over spray and bounce back spray in a paint spray booth.

In brief, the present invention provides a device for protecting a surface from the over spray and bounce back spray in a paint spray booth. The device comprises a plurality of flexible sheets. An adhesive is applied to at least a portion of one side of each sheet for both detachably securing the sheets together in a stack as well as to also detachably secure the end sheet in the stack to the surface to be protected.

A tab is secured to each sheet and preferably in one corner of the stack. These tabs enable the sheet associated with the stack to be detached from the stack by simply pulling the tab away from the stack.

In the preferred embodiment, the sheets are made of a transparent material, such as transparent plastic. Thus, the stack can be applied across a window and still allow visibility from outside the paint spray booth and to the inside of the paint spray booth.

In operation, after the stack has been applied to the object to be protected, paint spray gradually accumulates on the exposed side of the stack during the operation of the paint spray booth. When the amount of accumulated paint spray becomes excessive to an unacceptable level, the end sheet from the exposed side of the stack is removed from the stack and discarded. In removing the end sheet from the stack, the accumulated paint spray on the end sheet is likewise simultaneously removed thus providing a clean sheet unobscured by paint spray. When the device of the present invention is applied to a window, removal of the end sheet obscured with the paint spray restores visibility through the window.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a view illustrating preparation for applying the device of the present invention to an object to be protected;

FIG. 2 is illustrates the installation of the device of the present invention to a surface to be protected;

FIG. 3 is an enlarged view illustrating one corner of the device of the present invention;

FIG. 4 is a view illustrating the removal of one sheet from the stack of the device of the present invention;

FIG. 5 is a view similar to FIG. 4 but illustrating the removal of the exposed sheet when almost totally removed; and

FIG. 6 illustrates the device of the present invention following removal of the obscured sheet.

### DETAILED DESCRIPTION OF A PREFERRED EMBODIMENT OF THE PRESENT INVENTION

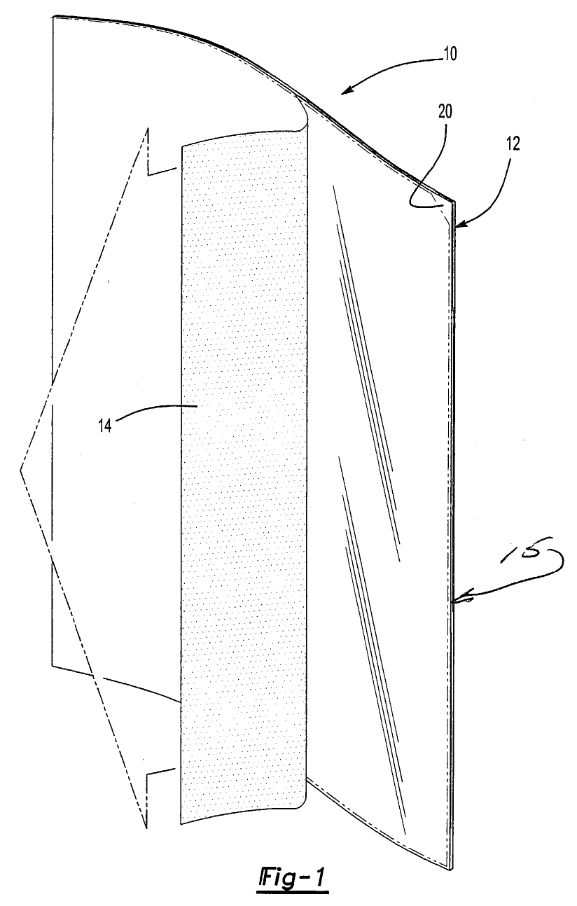

With reference first to FIG. 1, a preferred embodiment of the device 10 of the present invention is there shown and comprises a plurality of flexible sheets 12 arranged in a stack 15. An adhesive is applied to at least a portion of one side of each sheet for both detachably securing the sheets 12 together in a stack as well as for also detachably securing an end sheet in the stack to a surface to be protected. Preferably, a backing sheet 14 is secured to the end or bottom sheet which covers the adhesive on the end sheet prior to use of the device 10 of the present invention. The backing sheet 14 enables the devices 10 to be stacked together or otherwise shipped and stored prior to use without the devices 10 undesirably adhering together.

In FIG. 1, the backing sheet 14 is first removed from the end sheet 12 thus exposing the adhesive on the end sheet. The backing 14 is then discarded.

With reference now to FIG. 2, the device 10 of the present invention is there shown being applied to a surface 16 to be protected from paint spray. In applying the device 10 to the surface 16, the end sheet 12 is applied to and thus adhesively adhered to the surface 16. Simultaneously, the backing strip 14 is removed from the device 10 by peeling the backing strip 14 from the end sheet 12 thus exposing the adhesive on the end sheet 12 and allowing the end sheet 12 to be adhesively applied to the surface 16 to be protected.

Preferably, each sheet 12 is made of a transparent plastic material. Thus, when the sheets 12 are applied to a window, visibility through that window is maintained. The device 10, however, is not limited to protecting the windows within the spray booth. Rather, the device 10 can be applied to any surface 16 within the spray booth for which protection is desired.

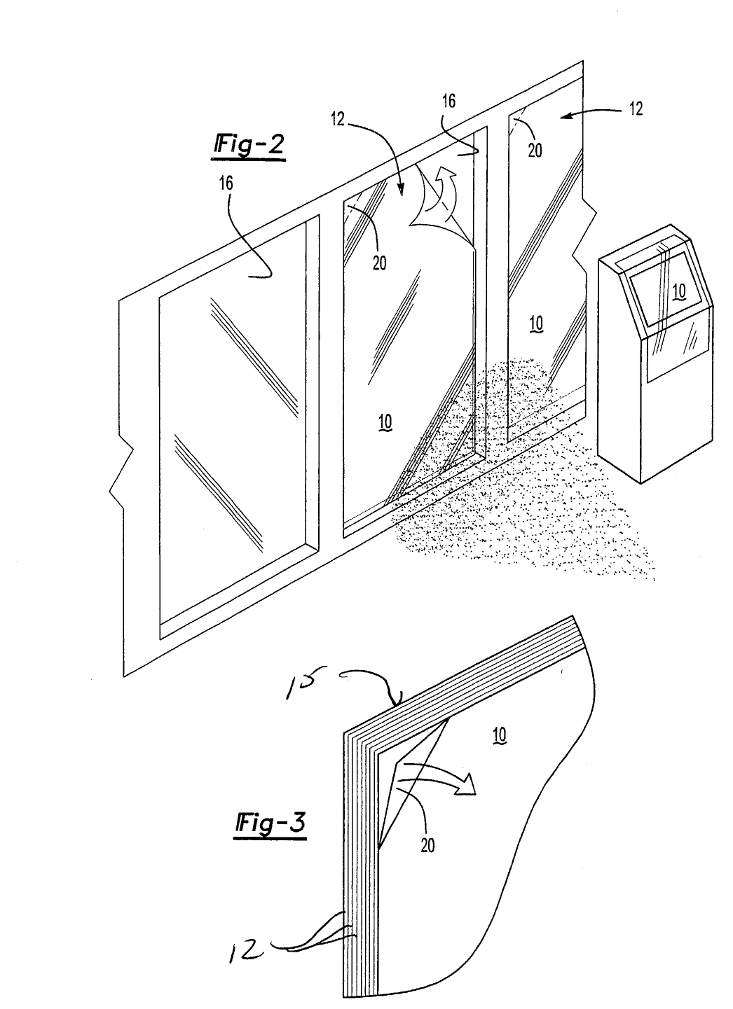

With reference now to FIG. 3, a tab 20 is associated with each sheet 12. Preferably, the tabs 20 are positioned in one corner of each sheet 12. Thus, assuming that the device 10 comprises, for example, ten sheets 12, ten tabs 20 will also be stacked upon each other and form the stack 15. The tabs 20, however, are not adhesively secured together, but rather are separated from each other to enable each tab 20 to be manually gripped when necessary.

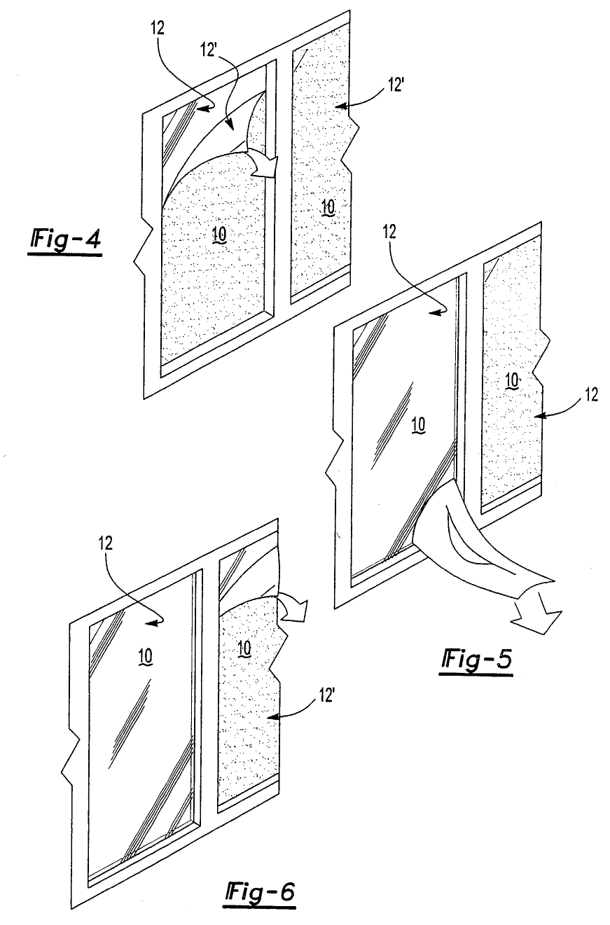

With reference now to FIG. 4, after the exposed end sheet 12′, i.e. the sheet 12′ exposed to the interior of the paint spray booth, has become obscured with paint, the exposed end sheet 12′ may be easily removed from the stack 15 of sheets 12. This is achieved by a user 22 grasping the tab 20′ on the sheet 12′ and peeling the sheet 12′ away from the stack as shown in FIG. 4.

FIG. 5 illustrates removal of the exposed sheet 12′ when almost completely removed from the stack while FIG. 6 illustrates the device 10 of the present invention following the complete removal of the exposed and paint covered sheet 12′.

After the exposed sheet 12′, together with its accumulated paint spray, has been removed from the device 10, a clean surface on the device 10 replaces the previously removed sheet 12′ that has been obscured by paint. Thus, in the situation where the protected surface 16 is a window, visibility through the device 10 is restored.

Since the individual sheets 12 can be easily and quickly removed from the stack 15, thus simultaneously removing the accumulated paint, cleaning of the paint spray booth may be rapidly accomplished.

Having described my invention, however, many modifications thereto will become apparent to those skilled in the art to which it pertains without deviation from the spirit of the invention as defined by the scope of the appended claims.

I claim:

1. A device for protecting a surface from paint spray in a paint spray booth comprising:
a plurality of flexible sheets,
an adhesive applied to at least a portion of one side of each sheet for both detachably securing said sheets together in a stack and also for detachably securing an end sheet in said stack to the surface to be protected, and
a tab secured to each sheet which enables removal of its associated sheet from the stack.

2. The invention as defined in claim 1 wherein each sheet is made of a transparent material.

3. The invention as defined in claim 1 wherein each sheet comprises a transparent plastic material.

4. The invention as defined in claim 1 and comprising a backing sheet detachably mounted to one side of said stack.

5. The invention as defined in claim 1 wherein each said tab comprises a portion of its associated sheet, each said tab being adhesive free on both sides.

6. The invention as defined in claim 5 wherein said tabs are positioned in a corner of said sheets.
